(19) United States
(12) Patent Application Publication
(10) Pub. No.: US 2016/0092616 A1
(43) Pub. Date: Mar. 31, 2016

(54) THERMAL SIMULATIONS USING CONVOLUTION AND ITERATIVE METHODS

(71) Applicant: QUALCOMM Incorporated, San Diego, CA (US)

(72) Inventors: Ryan Michael Coutts, Carlsbad, CA (US); Arpit Mittal, San Diego, CA (US); Rajat Mittal, San Diego, CA (US); Mohamed Waleed Allam, San Diego, CA (US); Mehdi Saeidi, San Diego, CA (US)

(21) Appl. No.: 14/502,752

(22) Filed: Sep. 30, 2014

(51) Int. Cl. G06F 17/50; G06F 17/15

(52) U.S. Cl. CPC G06F 17/5009; G06F 17/15

(57) ABSTRACT

Systems and methods for performing thermal simulations of a system are disclosed herein in. In one embodiment, a computer-implemented method for thermal simulation comprises determining a leakage power profile for a circuit in the system, adding the leakage power profile to a dynamic power profile of the circuit to obtain a combined power profile, and convolving the combined power profile with an impulse response to obtain a thermal response at a location on the system.

### BACKGROUND

1. Field

Aspects of the present disclosure relate generally to thermal simulations, and more particularly, to thermal simulations using convolution and iterative methods.

2. Background

Thermal simulations of a system (e.g., mobile device) may be performed during design of the system. For example, thermal simulations may be performed to verify that a chip (die) in the system does not overheat during sustained operation. This may be done to prevent the chip from entering thermal runaway, which can damage the chip. In another example, when the system is a mobile device, thermal simulations may be performed to verify that the surface temperature of the device does not become too hot to the touch for a user of the device.

Based on the results of thermal simulations, one or more aspects of the system design may be changed to improve system performance within thermal constraints. For example, the layout of the chip may be changed, the operating frequency of a circuit (e.g., central processing unit (CPU)) on the chip may be changed, the arrangement of components in the system may be changed, etc. After implementing one or more changes, thermal simulations may be performed to determine system performance with the changes. This process may be repeated to improve system performance within thermal constraints.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to a first aspect, a computer-implemented method for thermal simulation is described herein. The method comprises determining a leakage power profile for a circuit in a system, adding the leakage power profile to a dynamic power profile of the circuit to obtain a combined power profile, and convolving the combined power profile with an impulse response to obtain a thermal response at a location on the system.

A second aspect relates to a computer-implemented method for thermal simulation. The method comprises determining a first temperature profile for a circuit in a system, determining a first leakage power profile for the circuit based on the first temperature profile, and determining a second temperature profile for the circuit based on the first leakage power profile.

A third aspect relates to a computer-implemented method for thermal simulation. The method comprises determining a power scaling profile for a circuit in a system, multiplying the power scaling profile with a dynamic power profile of the circuit to obtain a combined power profile, and convolving the combined power profile with an impulse response to obtain a thermal response at a location on the system.

A fourth aspect relates to a computer-implemented method for thermal simulation. The method comprises determining a first temperature profile for a circuit in a system, determining a power scaling profile for the circuit based on the first temperature profile, and determining a second temperature profile for the circuit based on the power scaling profile and a dynamic power profile of the circuit.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 shows an example of a system for which thermal simulations may be performed.

FIG. 2 shows an example of a step power and a thermal response to the step power according to an embodiment of the present disclosure.

FIGS. 3A and 3B show examples of power profiles according to embodiments of the present disclosure.

FIG. 3C shows an example of a system for adjusting the dynamic power according to an embodiment of the present disclosure.

FIG. 4 shows an exemplary thermal response computed using convolution according to an embodiment of the present disclosure.

FIG. 5 shows a flowchart of an iterative process for computing a leakage power profile according to an embodiment of the present disclosure.

FIG. 6 shows an example of a system with temperature-dependent power control according to an embodiment of the present disclosure.

FIG. 7 shows an example of two temperature profiles and an error profile for a system with temperature-dependent power control according to embodiment of the present disclosure.

FIGS. 8A and 8B show a flowchart of an iterative process for computing a controlled power profile according to an embodiment of the present disclosure.

FIG. 9 shows another example of a system for which thermal simulations may be performed.

FIG. 10 shows a flowchart of a method for thermal simulation according to an embodiment of the present disclosure.

FIG. 11 shows a flowchart of a method for thermal simulation according to another embodiment of the present disclosure.

FIG. 12 shows a flowchart of a method for thermal simulation according to yet another embodiment of the present disclosure.

FIG. 13 shows a flowchart of a method for thermal simulation according to still another embodiment of the present disclosure.

FIG. 14 illustrates an electronic system with which features of the subject technology may be implemented.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Thermal simulations of a system (e.g., mobile device) may be performed during design of the system. For example, thermal simulations may be performed to verify that a chip (die) in the system does not overheat during sustained operation. This may be done to prevent the chip from entering thermal runaway. Thermal runaway occurs when increases in temperature causes leakage power to increase, which, in turn, causes further increases in temperature. The resulting positive feedback can cause the temperature of the chip to rapidly increase, potentially damaging the chip. In another example, when the system is a mobile device, thermal simulations may be performed to verify that the surface temperature of the device does not become too hot to the touch for a user of the device.

Based on the results of thermal simulations, one or more aspects of the system design may be changed to improve system performance within thermal constraints. For example, the layout of the chip may be changed, the operating frequency of a circuit (e.g., central processing unit (CPU)) on the chip may be changed, the arrangement of components in the system may be changed, etc. After implementing one or more changes, thermal simulations may be performed to determine system performance with the changes. This process may be repeated to improve system performance within thermal constraints.

Current thermal simulators are computationally complex, and, as a result, have long simulation times. For example, a state-space thermal simulator may take hours (e.g., eight hours) and/or require multiple computers to perform a single thermal simulation of a system. The long simulation times may make it impractical to perform thermal simulations for different scenarios (e.g., different operating frequencies). In addition, current thermal simulators do not have the ability to accurately model leakage power in a system or temperature-dependent power control in a system.

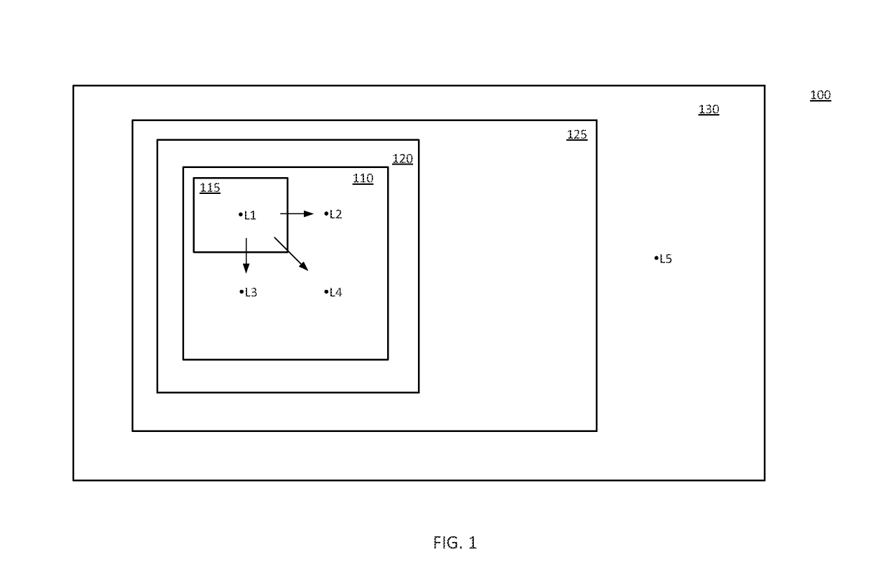

FIG. 1 shows a simplified conceptual diagram of a system 100 for which thermal simulations may be performed. The system 100 may comprise a chip (die) 110, a chip package 120, a board (e.g., printed circuit board) 125, and a housing 130. The chip 110 may comprise a circuit 115 (e.g., CPU) that consumes power during operation, and therefore generates heat, as discussed further below. Although one circuit 115 is shown in FIG. 1 for ease of discussion, it is to be appreciated that the chip 110 may comprise a plurality of circuits (e.g., one or more CPUs, a graphics processing unit (GPU), a modem, etc.). The chip 110 may be packaged in the chip package 120, and the chip package 120 may be mounted on the board 125. It is to be appreciated that other components (not shown) of the system 100 may also be mounted on the board 125. The board 125 may be enclosed in the housing 130. For the example in which the system 100 is a mobile device, the outer surface of the housing 130 may come into contact with a user of the mobile device. It is to be appreciated that FIG. 1 is not drawn to scale.

During operation, the circuit 115 consumes dynamic power (e.g., due to transistor switching), which may be approximately proportional to an operating frequency of the circuit 115 and the square of a supply voltage of the circuit 115. As the circuit 115 consumes power, heat generated by the power consumption flows to other portions of the system 100 due to thermal coupling. The heat flow (heat transfer) causes the temperature at the other portions of the system 100 to increase. The heat flow within the chip 115 is represented by arrows in FIG. 1.

In this regard, one or more thermal simulations may be performed to determine temperature changes (thermal responses) at different locations on the system 100 due to power consumption by the circuit 115. The locations may include one or more locations on the chip, one or more locations on the housing 130, and/or one or more other locations of interest on the system 100.

FIG. 1 shows an example in which thermal responses to power consumption by the circuit 115 are determined at five locations on the system 100 (denoted “L1” to “L5”). In this example, location L1 is within the circuit 115, locations L2 to L4 are on the chip 110 outside of the circuit 115, and location L5 is on the housing 130. The thermal responses at locations L1 to L4 on the chip 115 may be used, for example, to predict whether power consumption by the circuit 115 will lead to thermal runaway. It is to be appreciated that embodiments of the present disclosure are not limited to the example shown in FIG. 1. For example, if a thermal simulation is only performed for the chip 110, then each location at which a thermal response is determined may be on the chip 110. In general, a thermal simulation may be performed for the complete system 100 or a portion of the system 100.

Methods for performing thermal simulations for different power scenarios using convolution will now be described according certain embodiments of the present disclosure. The methods will be described below with reference to the exemplary system 100 shown in FIG. 1 for ease of discussion. However, it is to be appreciated that the methods are not limited to this example, and may be applied to other systems.

Initially, a thermal simulator (e.g., state-space thermal simulator) is used to simulate thermal responses at locations L1 to L5 to a step power at the circuit 115. The thermal simulator may run on one or more computers, and may simulate the thermal responses at the different locations based on a mathematical model (e.g., state-space model) of the system 100 modeling the thermal behavior of the system 100.

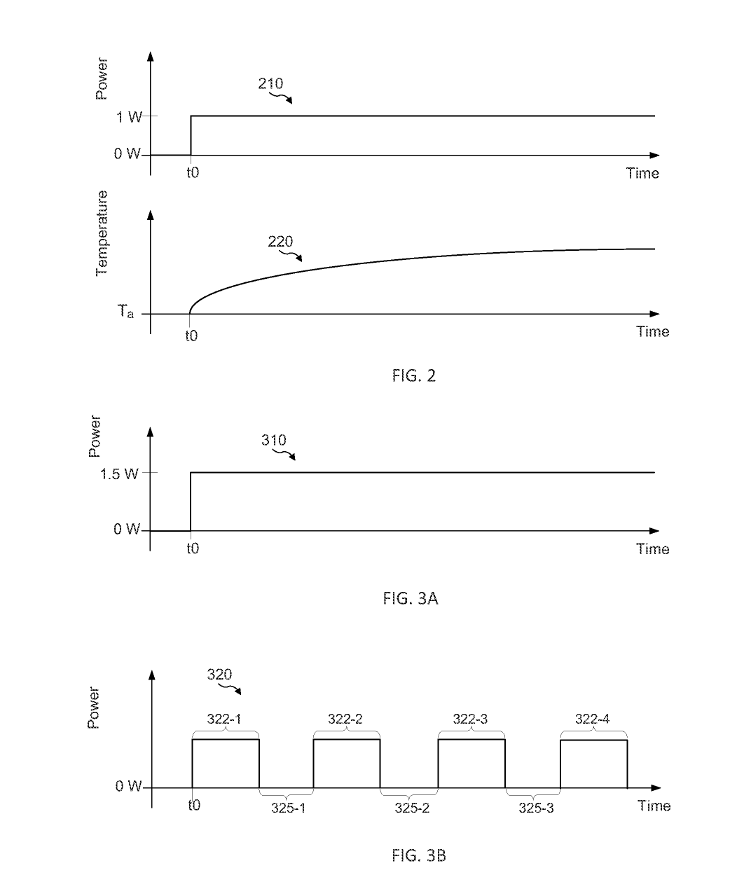

FIG. 2 shows an example of a step power 210 at the circuit 115. In this example, the step power 210 jumps from zero watts to one watt at time t0, and is held constant at one watt thereafter. Thus, a step power is input to the thermal simulator as the power for the circuit 115.

The thermal simulator computes a step response at each location L1 to L5 (i.e., thermal response at each location L1 to L5 to the step power at the circuit 115). In this regard, FIG. 2 shows an exemplary step response 220 at location L1, in which the temperature at location L1 increases in response to the step power 210. As shown in FIG. 2, the temperature at location L1 increases from an ambient temperature (denoted “Tₐ”) due to the step power 210, where the ambient temperature may be room temperature (e.g., 25° C.) or another temperature. In one aspect, the ambient temperature may be subtracted from the step response, in which case, the step response represents an increase in temperature at location L1 due to the power step. The step responses at the other locations L2 to L5 may be similarly computed.

The step response 220 may be determined over a time period for which it is desired to simulate the temperature at location L1. Although FIG. 2 shows the step response 220 as a continuous-time response, it is to be appreciated that the step response 220 may be represented as a discrete-time response comprising a sequence of temperature values, where each temperature value represents an increase in temperature due to the step power at a different point in time, as discussed further below.

After the step response at each location L1 to L5 is determined, a thermal impulse response at each location L1 to L5 may be determined based on the respective step response. For example, the impulse response at each location L1 to L5 may be determined by computing a derivative of the respective step response with respect to time. The impulse response at each location L1 to L5 may be denoted by Hₘ(t), where the index m indicates the respective location. For example, H₁(t) denotes the impulse response at location L1, H₂(t) denotes the impulse response at location L2, and so forth.

After the impulse response at each location L1 to L5 is determined, the thermal response at each location L1 and L5 to an arbitrary power profile (power over time) at the circuit 115 may be computed by convolving the respective impulse response with the power profile. This is because the impulse response at each location characterizes the thermal response at the respective location to a power input at the circuit 115.

In one aspect, the thermal response at each location to an arbitrary power profile may be computed by convolving the power profile with the respective impulse response Hₘ(t) as follows:

TRₘ(t)=Hₘ(t)*P(t) (1)

where * represents a convolution operation, P(t) is the power profile, TRₘ(t) is the thermal response, and the index m represents the respective location. The temperature profile (temperature over time) at each location may be given by:

Tₘ(t)=Hₘ(t)*P(t)+Tₐ (2)

where Tₘ(t) is the temperature, Tₐ is the ambient temperature (e.g., 25° C.), and the index m represents the respective location. Thus, the temperature profile at each location may be determined by adding the ambient temperature to the respective thermal response.

Thus, once the impulse response is computed at each location, the thermal response at each location L1 and L5 to an arbitrary power profile (power over time) can be quickly computed by convolving the power profile with the respective impulse response. This drastically reduces simulation time since performing a convolution operation is much faster (e.g., over 20,000 times) than performing a state-space thermal simulation for the power profile. As a result, when a designer makes a change to the power profile of the circuit 115, the designer can quickly see the resulting changes in the thermal responses at the different locations on the system 100 (i.e., quickly see the effect of the change on the thermal performance of the system). This allows the designer to try out many different power profiles to improve thermal performance of the system, and/or determine which power profiles stay within thermal constraints of the system 100 (e.g., stay below temperatures at which thermal runaway occurs).

Thus, the computational-intensive state-space thermal simulation may only need to be performed once to determine the impulse responses at the different locations on the system. Once the impulse responses are determined, thermal responses at locations L1 to L5 to different power profiles may be computed with substantially reduced simulation times using convolution.

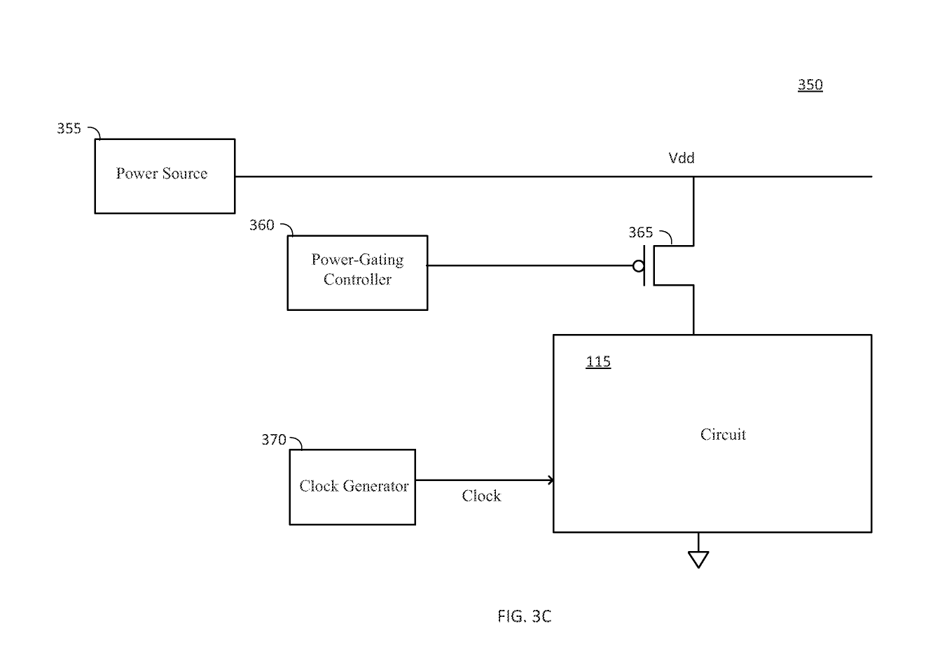

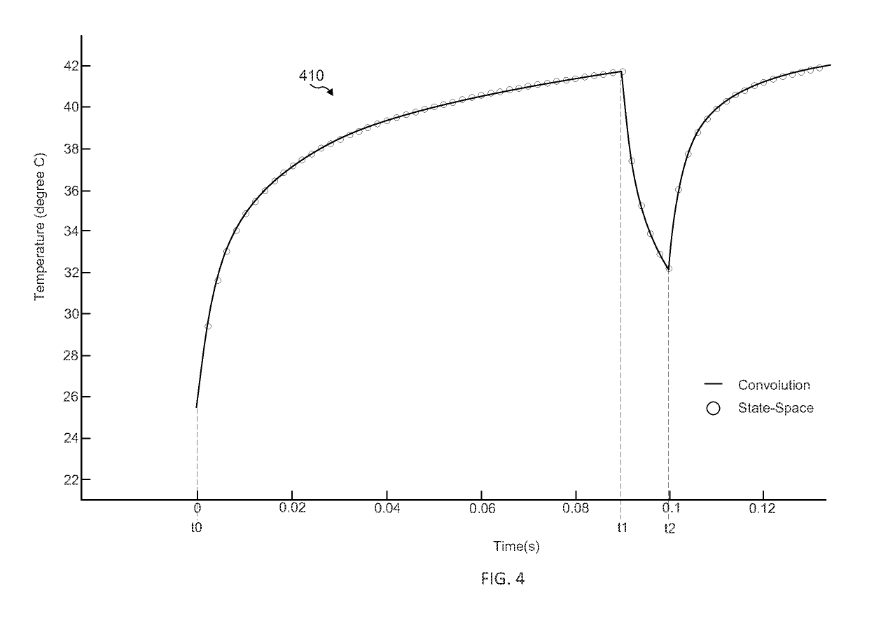

FIGS. 3A to 3B show examples of power profiles 310 and 320 for which thermal responses may be quickly computed using convolution. More particularly, FIG. 3A shows an example of a power profile 310 in which power consumption by the circuit 115 is held relatively constant at a power level other than one watt (e.g., 1.5 watts). In this example, the thermal responses at locations L1 to L5 to the power profile 310 may be quickly computed by convolving the power profile 310 with the impulse responses at locations L1 to L5. A designer may change the power level of the power profile 310, and quickly see the resulting changes in the thermal responses at locations L1 to L5 by convolving the changed power profile with the impulse responses at locations L1 to L5. The power level of the power profile 310 may be changed, for example, by changing the operating frequency of the circuit 115 and/or supply voltage of the circuit 115.

FIG. 3B shows an example of a power profile 320 in which the circuit 115 is power gated. The circuit 115 may be power gated, for example, to reduce power consumption when the circuit 115 is not in use (e.g., in an idle state) by powering off the circuit 115 when the circuit 115 is not in use. In the example shown in FIG. 3B, the circuit 115 is powered on during time durations 322-1 to 322-4 and powered off during time durations 325-1 to 325-3. In this example, the thermal responses at locations L1 to L5 to the power profile 320 may be quickly computed by convolving the power profile 320 with the impulse responses at locations L1 to L5. A designer may change the power profile 320 (e.g., by changing the time durations during which the circuit 115 is powered off), and quickly see the resulting changes in the thermal responses at locations L1 to L5 by convolving the changed power profile with the impulse responses at locations L1 to L5. This allows the designer to try out different power gating scenarios, and quickly see the effects the different power gating scenarios have on the thermal performance of the system 100. As a result, the designer is able to quickly determine thermal performance for different power gating scenarios. It is to be appreciated that embodiments of the present disclosure are not limited to the exemplary power profiles shown in FIGS. 3A and 3B, and may be used to compute thermal responses to other power profiles.

FIG. 3C shows an example of a system 350 for varying the dynamic power of the circuit 115 according to an embodiment. The system 350 comprises a power source 355, a power-gating controller 360, a power switch 365, and a clock generator 370. The power source 355 provides a supply voltage Vdd to the circuit 115, and may comprise a voltage regulator, a power management integrated circuit (PMIC), etc. In this embodiment, the power profile 310 shown in FIG. 3A or other power profile may be varied by adjusting the supply voltage Vdd provided by the power source 355. For example, the amplitude of the power level of the power profile 310 may be increased by increasing the supply voltage Vdd provided by the power source 355. After adjusting the supply voltage Vdd (and hence the power profile), the resulting changes in the thermal responses at one or more locations of the system 100 may be quickly determined by convolving the power profile with the impulse responses at the one or more locations.

The clock generator 370 is configured to generate a clock signal for the circuit 115, which may use the clock signal for switching (toggling) transistors in the circuit 115. In this embodiment, the frequency of the clock signal may correspond to the operating frequency of the circuit 115. Thus, the operating frequency of the circuit 115 may be varied by varying the clock frequency of the clock generator 370. In this embodiment, the power profile 310 shown in FIG. 3A or other power profile may be varied by adjusting the clock frequency of the clock generator 370. For example, the amplitude of the power level of the power profile 310 may be increased by increasing the clock frequency, in which the amplitude of the power level may be approximately proportional to the clock frequency. After adjusting the clock frequency (and hence the power profile), the resulting changes in the thermal responses at one or more locations of the system 100 may be quickly determined by convolving the power profile with the impulse responses at the one or more locations.

The power-gating controller 360 and the power switch 365 are configured to power gate the circuit 115. In this regard, the power switch 365 (e.g., one or more PMOS transistors) is coupled between the power source 355 and the circuit 115, and the power-gating controller 360 turns the power switch 365 one and off to power gate the circuit 115. For example, the power-gating controller 360 may power on the circuit 115 by turning on the power switch 365 and power off the circuit 115 by turning off the power switch 365. In this embodiment, the power profile 320 shown in FIG. 3B or other power profile may be varied by adjusting the time durations during which the power-gating controller 360 turns off the power switch 365. After adjusting the time durations during which the power switch is turned off (and hence the power profile), the resulting changes in the thermal responses at one or more locations of the system 100 may be quickly determined by convolving the power profile with the impulse responses at the one or more locations.

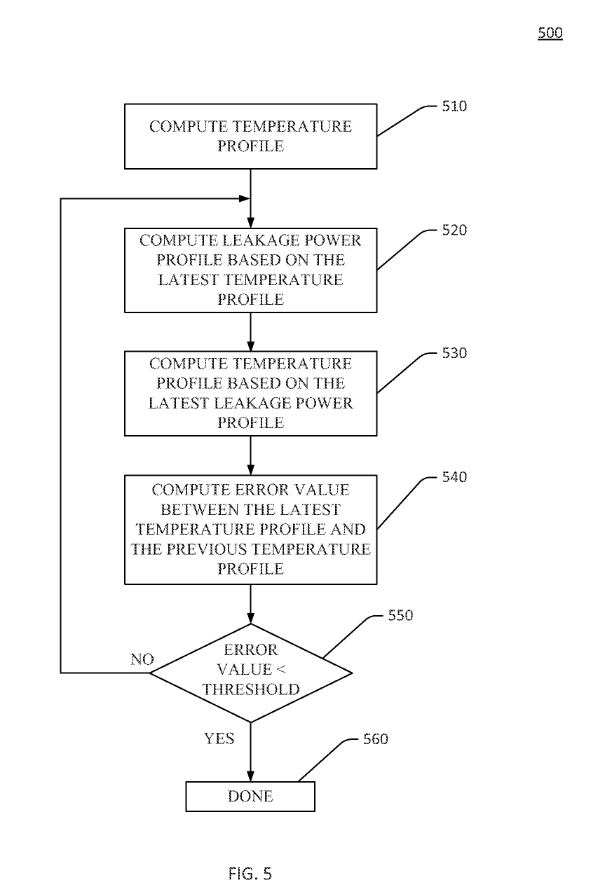

FIG. 4 shows an exemplary thermal response 410 computed using convolution and an exemplary thermal response (represented by open circles) computed using a state-space thermal simulator. In this example, both thermal responses are computed for the same location and power profile. The power profile is associated with a CPU, in which the CPU is powered on at time t0, powered off at time t1, and powered back on at time t2. The location of the thermal response is within the CPU. The thermal response 410 is computed by convolving the power profile with the impulse response at the location.

In this example, the temperature rises from the ambient temperature (25° C.) when the CPU is powered on at time t0. When the CPU is powered off at time t1, the temperature drops, and, when the CPU is powered back on at time t2, the temperature rises again. As shown in FIG. 4, the thermal response 410 computed using convolution is approximately the same as the thermal response computed using the state-space thermal simulator, and therefore has approximately the same accuracy. However, the thermal response 410 computed using convolution is computed in much less time than the thermal response computed by the state-space thermal simulator. Thus, embodiments of the present disclosure are capable of providing approximately the same accuracy as a state-space thermal simulator in much less time.

In certain embodiments, thermal responses that take into account leakage power at the circuit 115 may be computed. Leakage power is power consumed due to sub-threshold current leakage of transistors in the circuit 115. As temperature increases, the current leakage increases. Thus, leakage power increases with temperature, and is therefore temperature dependent. Leakage power as a function of temperature can be modeled by the following:

L(T)=β·e^{α(T-T}^{_{α}}⁾ (3)

where L(T) is the leakage power, T is temperature at the circuit 115, Tₐ is the ambient temperature (e.g., 25° C.), β is the leakage power at the ambient temperature, and α is an acceleration factor. The leakage power may be an aggregate of the leakage powers of the transistors in the circuit 115, where the leakage power of each transistor may depend on the threshold voltage of the transistor and/or other properties of the transistor. It is also to be appreciated that leakage power may also be proportional to the supply voltage of the circuit 115.

An iterative process for computing a leakage power profile (leakage power over time) for a circuit will now be described according to certain embodiments. For ease of discussion, reference is made to the circuit 115 in the exemplary system 100 shown in FIG. 1, although it is to be appreciated that the iterative process is not limited to this example, and may be applied to other circuits with leakage power.

In a first iteration, the temperature profile at location L1 (location within the circuit 115) is computed based on a dynamic power profile of the circuit 115 without taking into account leakage power as follows:

T_{1,int}_{_{—}}₁(t)=H₁(t)*P(t)+Tₐ (4)

where int denotes the iteration, and P(t) is the dynamic power profile. Thus, the temperature profile for the first iteration is computed by convolving the dynamic power profile with the impulse response at location L1 and adding the ambient temperature.

In a second iteration, the temperature profile at location L1 is computed as follows:

T_{1,int}_{_{—}}₂(t)=H₁(t)*(P(t)+L(T_{1,int}_{_{—}}₁(t)))+Tₐ (5)

where L( ) is the leakage power profile as a function of the temperature profile at location L1 and P(t) is the dynamic power profile. Thus, the leakage power profile in the second iteration is computed based on the temperature profile computed in the first iteration. As shown in equation (5), the leakage power profile is added to the dynamic power profile to obtain a combined power profile for the circuit 115. The combined power profile reflects the total power consumption of the circuit 115 due to dynamic power (e.g., power consumption due to gate switching) and leakage power (e.g., power consumption due to leakage current, which is a function of temperature). The combined power profile is convolved with the impulse response at location L1 to obtain the thermal response at location L1 to the combined power profile. The ambient temperature is then added to the thermal response to obtain the temperature profile for the second iteration.

After the second iteration, an error value may be computed based on the difference between the temperature profile for the first iteration and the temperature profile for the second iteration. For example, the error value may be computed based on a mean squared error (MSE) between the temperature profile for the first iteration and the temperature profile for the second iteration. If the error value is below an error threshold (which may be close to zero), then the iterative process may stop. Otherwise, the iterative process may proceed to a third iteration.

In the third iteration, the temperature profile at location L1 (location within the circuit 115) is computed as follows:

T_{1,int}_{_{—}}₃(t)=H₁(t)*(P(t)+L(T_{1,int}_{_{—}}₂(t)))+Tₐ (6).

Thus, the leakage power profile in the third iteration is computed based on the temperature profile computed in the second iteration. As a result, the leakage power component (leakage power profile) of the combined power profile is updated based on the temperature profile from the second iteration. After the third iteration, an error value may be computed based on the difference between the temperature profile for the second iteration and the temperature profile for the third iteration. If the error value is below the error threshold, then the iterative process stops. Otherwise, the iterative process may proceed to a fourth iteration.

In each subsequent iteration of the iterative process, the leakage power profile for the iteration is computed based on the temperature profile computed in the previous iteration. The iterative process may continue until the error value between the temperature profiles for two consecutive iterations is below the error threshold. When the iterative process ends, the combined power profile for the circuit 115 may be computed by adding the dynamic power profile to the leakage power profile for the last iteration. Thus, the combined power profile takes into account leakage power at the circuit 115, and therefore provides a more accurate representation of the power consumption by the circuit 115.

The leakage power of the circuit 115 may be assumed to increase monotonically with temperature. This causes the error value to decrease with successive iterations, and therefore allows the iterative process to converge on a solution for the temperature profile and the leakage power profile. In one aspect, the temperature profile at the circuit may be bounded by an upper temperature limit to allow the iterative process to converge on a solution for the temperature profile and the leakage power profile for cases where the circuit 115 enters thermal runaway, as discussed further below.

In the above example, the leakage power is assumed to be zero in the first iteration. However, it is to be appreciated that embodiments of the present disclosure are not limited to this example. For example, a leakage power profile may be computed in the first iteration based on a temperature profile in which the temperature is assumed to be constant at the ambient temperature. This may allow the iterative process to converge faster on a solution for the temperature profile and the leakage power profile.

As discussed above, the temperature profile at the circuit 115 may be bounded by an upper temperature limit. In this embodiment, when a portion of the temperature profile reaches the upper temperature limit, that portion may be capped at the upper temperature limit. This is done to allow the iterative process to converge on a solution for the temperature profile and the leakage power profile for cases where the circuit 115 enters thermal runaway. If the upper temperature limit is reached, then a designer may be alerted that the upper temperature limit has been reached. In this case, the designer may conclude that the current system design will lead to thermal runaway, and modify the design accordingly. In addition, an indication may be provided to the designer indicating at which point in time the upper temperature limit was reached by the temperature profile. This information may help the designer diagnose the cause of the thermal runaway, and/or design the system to power off the circuit before the upper temperature limit is reached.

After the combined power profile for the circuit 115 is determined using the iterative process, the temperature profile at each location L2 and L5 outside the circuit 115 may be updated by convolving the combined power profile with the respective impulse response and adding the ambient temperature. For example, the temperature profile at location L2 may be computed as follows:

T₂(t)=H₂(t)*(P(t)+L(T_{1,int}_{_{—}}ₗₐₛₜ(t)))+Tₐ (7)

where int_last denotes the last iteration in the iterative process. As discussed above, the combined power profile is the total power consumption of the circuit 115 due to dynamic power and leakage power. Thus, equation (7) determines the temperature profile at location L2 due to the total power consumption of the circuit 115. Therefore, the temperature profiles at locations L2 and L5 may be updated to account for leakage power at the circuit 115.

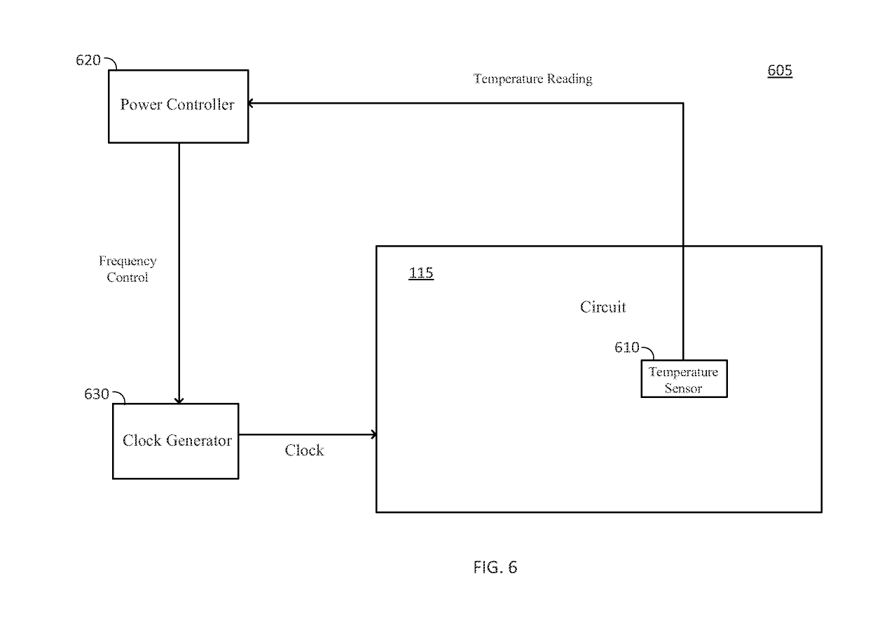

FIG. 5 is a flowchart illustrating an iterative process 500 for determining a leakage power profile according to an embodiment of the present disclosure.

In step 510, a temperature profile at a location within a circuit (e.g., circuit 115) due to power consumption of the circuit is computed. For example, the temperature profile may be computed by convolving a dynamic power profile for the circuit 115 with an impulse response at the location (e.g., location L1) within the circuit 115, and adding an ambient temperature (e.g., 25° C.).

In step 520, a leakage power profile for the circuit is computed based on the latest temperature profile for the circuit. When step 520 is performed for the first time, the latest temperature profile corresponds to the temperature profile computed in step 510.

In step 530, a temperature profile for the circuit is computed based on the latest leakage power profile. For example, the temperature profile may be computed by adding the latest leakage power profile to the dynamic power profile to obtain a combined power profile (total power consumption of the circuit due to dynamic power and leakage power), convolving the combined power profile with the impulse response, and adding the ambient temperature.

In step 540, an error value between the latest temperature profile and the previous temperature profile is computed. When step 540 is performed for the first time, the latest temperature profile corresponds to the temperature profile computed in step 530, and the previous temperature profile corresponds to the temperature profile computed in step 510. In one example, the error value may be computed by computing a MSE between the latest temperature profile and the previous temperature profile.

In step 550, the error value is compared to an error threshold. If the error value is below the error threshold, then the process 500 ends at step 560, and the latest leakage power profile is used as the leakage power profile for the circuit 115. Otherwise, the process 500 returns to step 520, in which case, steps 520 to 550 are repeated. Steps 520 to 550 may be repeated until the error value between the latest temperature profile and the previous temperature profile falls below the error threshold.

The temperature profile at a location may be represented as a discrete-time temperature profile comprising a sequence of N temperature values, where each temperature value represents the temperature at a different point in time, and adjacent temperature values are spaced apart by a time step of Δt. In other words, the temperature profile may be represented as a time sequence (time series) of N temperature values. In this regard, the temperature profile at a location may be given as follows:

\hat{T}ₘ=Tₘ[0],Tₘ[1], . . . , Tₘ[N−2],Tₘ[N−1] (8)

where \hat{T}ₘ is the discrete-time representation of the temperature profile, Tₘ [0] is the temperature value at time zero, Tₘ [1] is the temperature value at time Δt, Tₘ [N−2] is the temperature value at time (N−2)·Δt, Tₘ [N−1] is the temperature value at time (N−1)·Δt, and the index m indicates the respective location. The number in each bracket is a time index corresponding to a time equal to the time index multiplied by the time step Δt.

Similarly, the impulse response at a location may be represented as a discrete-time impulse response comprising a sequence of N impulse response values, where each impulse response value represents the impulse response at a different point in time, and adjacent impulse response values are spaced apart by a time step of Δt. In other words, the impulse response may be represented as a time sequence (time series) of N impulse response values. In this regard, the impulse response at a location may be given as follows:

Ĥₘ=Hₘ[0],Hₘ[1], . . . , Hₘ[N−2],Hₘ[N−1] (9)

where Ĥₘ is the discrete-time representation of the impulse response, Hₘ [0] is the impulse response value at time zero, Hₘ [1] is the impulse response value at time Δt, Hₘ [N−2] is the impulse response value at time (N−2)·Δt, Hₘ [N−1] is the impulse response value at time (N−1)·Δt, and the index m indicates the respective location.

Similarly, the dynamic power profile of the circuit 115 may be represented as a discrete-time power profile comprising a sequence of power values, where each power value represents the dynamic power consumed by the circuit 115 at a different point in time, and adjacent power values are spaced apart by a time step of Δt. In other words, the power profile may be represented as a time sequence (time series) of N power values. In this regard, the power profile may be given as follows:

\hat{P}=P[0],P[1], . . . , P[N−2],P[N−1] (10)

where \hat{P} is the discrete-time representation of the power profile, P[0] is the power value at time zero, P[1] is the power value at time Δt, and P[N−2] is the power value at time (N−2)·Δt, and P[N−1] is the power value at time (N−1)·Δt.

Equation (2) can be rewritten in discrete-time form as follows:

\hat{T}ₘ=Ĥₘ*\hat{P}+\hat{T}ₐ (11)

where \hat{T}ₐ comprises a sequence of N temperature values, in which each temperature value is equal to the ambient temperature (e.g., 25° C.). When leakage power is taken into account, the temperature profile at location L1 (location within the circuit) at iteration i of the iterative process discussed above can be written as:

\hat{T}_{1,int}_{_{—}}ᵢ=Ĥₘ*(\hat{P}+\hat{L}(\hat{T}_{1,int}_{_{—}}₍ᵢ₋₁₎))+Tₐ (12)

where \hat{L}( ) is a discrete-time representation of the leakage power profile as a function of a temperature profile, and \hat{L}( ) comprises a sequence of N leakage power values. As shown in equation (12), the leakage power profile for iteration i is computed based on the temperature profile computed in the previous iteration i−1. It is to be appreciated that the various methods discussed above for simulating the thermal performance of a system may be performed by a thermal simulator in the discrete-time domain using on equations (8) through (12).

The convolution operations in equations (11) and (12) may be efficiently computed by converting the power profile and impulse response from the time domain into the frequency domain using a discrete-time Fast Fourier Transform (FFT). The power profile and impulse response may then be multiplied in the frequency domain, and the resulting product may be converted back into the time domain using a discrete-time inverse FFT (IFFT) to obtain the corresponding thermal response in the time domain. Thus, FFT and IFFT operations may be used to accelerate the convolution operations.

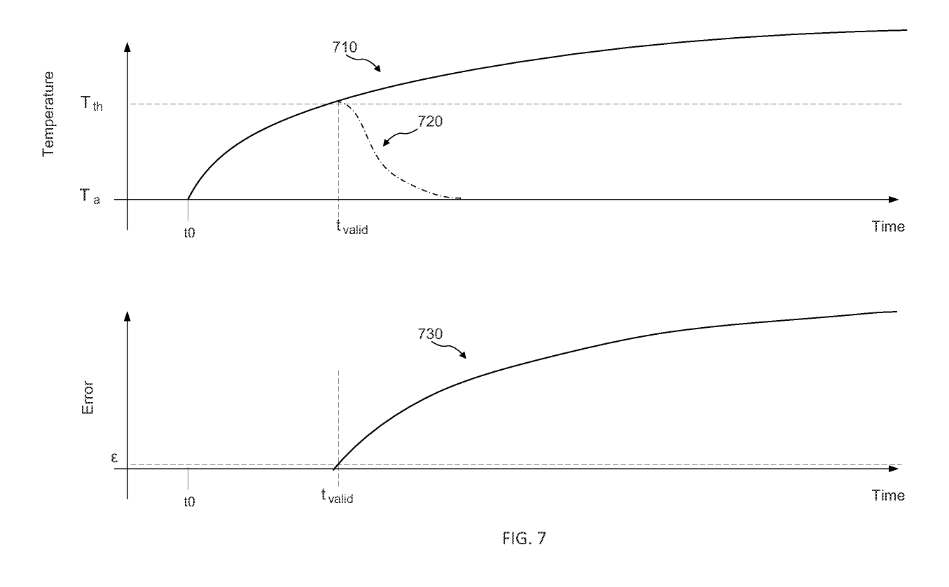

Embodiments of the present disclosure provide methods for performing thermal simulations for a circuit with temperature-dependent power control, as discussed further below. In this regard, FIG. 6 shows an example of a system 605 in which the dynamic power of the circuit 115 is controlled based on temperature. The system 605 comprises a temperature sensor 610, a power controller 620, and a clock generator 630.

The temperature sensor 610 is configured to measured temperature at a location (e.g., location L1) within the circuit 115 (e.g., CPU), and output a corresponding temperature reading to the power controller 620. The temperature sensor 610 may be integrated on the circuit 115, as shown in FIG. 6. The power controller 620 is configured to control the dynamic power of the circuit 115 based on temperature readings from the temperature sensor 610. In one aspect, the power controller 620 controls the dynamic power of the circuit 115 by adjusting (scaling) the operating frequency of the circuit 115. As discussed above, the dynamic power of the circuit 115 may be proportional to the operating frequency of the circuit 115, and may therefore be adjusted by adjusting the operating frequency of the circuit 115.

The clock generator 630 is configured to generate a clock signal for the circuit 115, and to adjust the frequency of the clock signal under the control of the power controller 620. The clock signal is output to the circuit 115, which may use the clock signal for switching (toggling) transistors in the circuit 115. In this example, the frequency of the clock signal may correspond to the operating frequency of the circuit 115. Thus, the power controller 620 may adjust (scale) the operating frequency (and hence dynamic power) of the circuit 115 by adjusting the frequency of the clock signal.

In one aspect, the power controller 620 may adjust the operating frequency (and hence dynamic power) of the circuit 115 based on a target operating frequency, a temperature threshold, and temperature readings from the temperature sensor 610. The target operating frequency may correspond to a desired operating frequency of the circuit 115, and the temperature threshold may correspond to a temperature near a maximum safe operating temperature of the circuit 115.

In this aspect, the circuit 115 may initially operate at the target operating frequency, and the power controller 620 may allow the circuit 115 to continue operating at the target operating frequency as long as the temperature of the circuit 115 (as indicated by temperature readings from the temperature sensor 610) is below the threshold temperature. When the temperature crosses the temperature threshold, the power controller 620 may activate temperature mitigation.

When temperature mitigation is activated, the power controller 620 may reduce (scale down) the operating frequency (and hence dynamic power) of the circuit 115 to reduce the temperature. This may cause the temperature to fall back down below the threshold temperature. When this occurs, the power controller 620 may increase (scale up) the operating frequency of the circuit 115 to increase the operational performance (e.g., data rate) of the circuit 115. More particularly, after temperature mitigation is activated, the power controller 620 may reduce the operating frequency (and hence dynamic power) when the temperature is above the temperature threshold, and may increase the operating frequency when the temperature is below the temperature threshold and the operating frequency is below the target frequency.

In one aspect, the power controller 620 may adjust the operating frequency using a proportional-integral-derivative (PID) controller, in which a difference between the temperature and target temperature is input to the PID controller and the PID controller outputs a control signal that controls the operating frequency based on the difference. In this aspect, one or more parameters (e.g., proportional coefficient, integral coefficient, derivative coefficient, etc.) of the PID controller may be adjusted to optimize the power control loop. It is to be appreciated that the power controller 620 may also employ other power control techniques to control dynamic power based on temperature, and is therefore not limited to a PID controller.

It is also to be appreciated that the power controller 620 may also adjust the dynamic power of the circuit 115 by adjusting a supply voltage of the circuit 115. As discussed above, the dynamic power of the circuit 115 may be proportional to the square of the supply voltage. Thus, the power controller 620 may adjust the dynamic power of the circuit 115 by adjusting the operating frequency and/or the supply voltage of the circuit 115.

In one aspect, the controlled dynamic power profile of the circuit 115 may be modeled as follows:

P_{c}(t)=P(t)·C(t) (13)

where P_{c}(t) is the controlled dynamic power profile, P(t) is the dynamic power profile at the target operating frequency, and C(t) is a power scaling profile. Thus, the controlled dynamic power profile P_{c}(t) is obtained by multiplying the dynamic power profile at the target frequency P(t) with the power scaling profile C(t). The power scaling profile C(t) models dynamic power scaling by the power controller 620 over time, which may be achieved by scaling the operating frequency and/or supply voltage of the circuit 115, as discussed above. The power scaling profile C(t) may range from zero to one, where zero is equivalent to powering off the circuit and one is equivalent to no power scaling. For example, a power scaling value of 0.9 may correspond to a power reduction of 10%.

The expression for the temperature profile given in equation (2) can be modified to take into account power control as follows:

Tₘ(t)=Hₘ(t)*(P(t)·C(t))+Tₐ (14)

where the index m represents the location of the temperature profile. Thus, the temperature profile at a location on the system 100 is computed by convolving the controlled dynamic power profile with the impulse response at the respective location and adding the ambient temperature. For ease of discussion, leakage power is not shown in equation (14).

In one aspect, the power scaling profile may be represented as a discrete-time power scaling profile comprising a sequence of N power scaling values, where each power scaling value corresponds to a different point in time, and adjacent power scaling values are spaced apart by a time step of Δt. In other words, the power scaling profile may be represented as a time sequence (time series) of N power scaling values. In this regard, the power scaling profile may be given as follows:

Ĉ=C[0],C[1], . . . , C[N−2],C[N−1] (15)

where Ĉ is the discrete-time representation of the power scaling profile, C[0] is the power scaling value at time zero, C[1] is the power scaling value at time Δt, and C[N−2] is the power scaling value at time (N−2)·Δt, and C[N−1] is the power scaling value at time (N−1)·Δt. The power scaling values for time points before temperature mitigation is activated may be all ones, which is equivalent to no power scaling before temperature mitigation is activated.

In one aspect, the discrete-time power scaling profile may be represented as a function of temperature at the circuit 115 as follows:

Ĉ=C[0],C[1], . . . , C[N−2],C[N−1]=1,C′[T[0]], . . . , C′[T[N−3]],C′[T[N−2]] (16)

where C′[ ] represents a power scaling value at a point in time as a function of the temperature value at a previous point in time (e.g., one time step Δt behind). This is because there is a short delay between the time the power controller 620 receives a temperature reading from the temperature sensor 610 and the time the power controller 620 adjusts the operating frequency and/or supply voltage based on the temperature reading. Thus, the power scaling value at a certain point in time is decided based on the temperature value at a previous point in time (e.g., one time step Δt behind). It is to be appreciated that the power scaling value at a certain point in time may also be a function of a plurality of past temperature values (e.g., when power control is based at least in part on an integration of temperature). As shown in equation (16), the power scaling value at time zero may be equal to one since there is no temperature reading prior to time zero upon which to make a decision for the power scaling value at time zero.

The expression for the temperature profile in equation (14) can be rewritten in discrete-time form as follows:

\hat{T}ₘ=Ĥₘ*(\hat{P}·Ĉ)+\hat{T}ₐ (17).

For ease of discussion, leakage power is not shown in equation (17).

An iterative process for computing a temperature profile for a circuit with temperature-dependent power control will now be described according to certain embodiments. For ease of discussion, reference will be made to the circuit 115 in the exemplary system 100 shown in FIG. 1, although it is to be appreciated that the iterative process is not limited to this example, and may be applied to other circuits with temperature-dependent power control.

In a first iteration, the temperature profile at location L1 (location within the circuit 115) is computed based on the dynamic power profile of the circuit 115 without power control as follows:

\hat{T}_{1,int}_{_{—}}₁=Ĥ₁*\hat{P}+\hat{T}ₐ (18)

where int denotes the iteration. Thus, the temperature profile for the first iteration is computed by convolving the dynamic power profile with the impulse response at location L1 and adding the ambient temperature.

In a second iteration, the power scaling profile is computed based on the temperature profile from the first iteration follows:

Ĉᵢₙₜ_{_{—}}₂=Cᵢₙₜ_{_{—}}₂[0],Cᵢₙₜ_{_{—}}₂[1], . . . , Cᵢₙₜ_{_{—}}₂[N−2],Cᵢₙₜ_{_{—}}₂[N−1]=1,C′[T_{1,int}_{_{—}}₁[0]], . . . , C′[T_{1,int}_{_{—}}₁[N−3]],C′[T_{1,int}_{_{—}}₁[N−2]] (19).

In equation (19), it is assumed that the power scaling value at a certain point in time is determined based on the temperature value at the previous time step. For example, as shown in equation (19), the power scaling value at time Δt (i.e., Cᵢₙₜ_{_{—}}₂[1]) is determined based on the temperature value at time zero (i.e., C′[T_{1,int}_{_{—}}₁[0]]). However, it is to be appreciated that embodiments of the present disclosure are not limited to this example, and that the power control may lag temperature by a different amount of time. The temperature profile for the second iteration is then computed as follows:

\hat{T}_{1,int}_{_{—}}₂=Ĥ₁*(\hat{P}·Ĉᵢₙₜ_{_{—}}₂) (20)

An error profile may then be computed based on the temperature profiles for the first and second iterations. More particularly, the error profile may comprise a sequence of error values, where each error value corresponds to an error between a pair of temperature values in the first and second temperature profiles corresponding to the same point in time. The error profile may then be evaluated to determine a point in time at which the error profile reaches an error threshold (denoted “ε”).

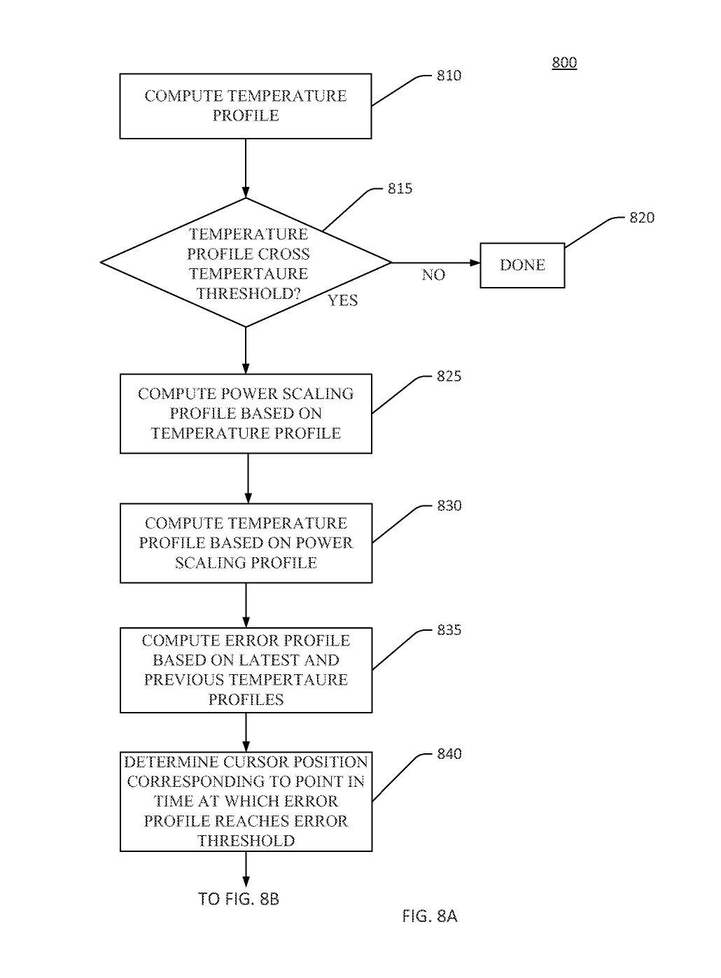

FIG. 7 shows an example of the temperature profile 710 for the first iteration and the temperature profile 720 for the second iteration. As shown in this example, the temperature profiles 710 and 720 for the first and second iterations are the same before the threshold temperature (denoted “Tₜₕ”) is reached. This is because the power controller 620 does not activate temperature mitigation until the threshold temperature is crossed. As a result, the power scaling profile is one (which is equivalent to no power control) until the temperature threshold is crossed.

FIG. 7 also shows the error profile 730 for the temperature profiles 710 and 730. As shown in FIG. 7, the error profile 730 is close to zero until the threshold temperature is crossed. Shortly after the temperature threshold is exceeded, the temperature profile 720 for the second iteration begins deviating from the temperature profile 710 for the iteration. This is because temperature mitigation is activated, and the power controller 620 begins adjusting the dynamic power of the circuit. As shown in the example in FIG. 7, the error profile 730 rapidly grows after temperature mitigation is activated. This is because the power scaling profile in the second iteration is computed based on the temperature profile 710 from the first iteration, in which the temperature profile 710 from the first iteration does not reflect the effect of the power control in the second iteration. As a result, the power control in the second iteration overcompensates the controlled dynamic power, causing the controlled dynamic power (and hence the temperature profile 720) to rapidly decrease. As shown in FIG. 7, the error profile 730 is below the error threshold 8 up to a point in time denoted by t_{valid}. Thus, from time zero to time t_{valid} the temperature profile 720 in the second iteration may be considered valid.

The iteration process then proceeds to a third iteration, in which the power scaling profile comprising a first portion and a second portion is computed. The first portion of the power scaling profile for the third iteration is set equal to a corresponding portion of the power scaling profile from the second iteration, and the second portion of the power scaling profile for the third iteration is computed based on the temperature profile from the second iteration. More particularly, the first portion of the power scaling profile for the third iteration extends from time zero to time aᵢₙₜ_{_{—}}₃·Δt, and the second portion of the power scaling profile for the third iteration extends from time (aᵢₙₜ_{_{—}}₃+1)·Δt to time (N−1)·Δt, where time aᵢₙₜ_{_{—}}₃·Δt is set equal to time t_{valid} discussed above. The power scaling profile for the third iteration is computed as follows:

Ĉᵢₙₜ_{_{—}}₃=Cᵢₙₜ_{_{—}}₃[0], . . . , Cᵢₙₜ_{_{—}}₃[aᵢₙₜ_{_{—}}₃],Cᵢₙₜ_{_{—}}₃[aᵢₙₜ_{_{—}}₃+1], . . . , Cᵢₙₜ_{_{—}}₃[N−1]=Cᵢₙₜ_{_{—}}₂[0], . . . , Cᵢₙₜ_{_{—}}₂[aᵢₙₜ_{_{—}}₃],C′[T_{1,int}_{_{—}}₂[aᵢₙₜ_{_{—}}₃]], . . . , C′[T_{1,int}_{_{—}}₂[N−2]] (21).

Thus, the power scaling profile for the third iteration is kept the same from the power scaling profile in the second iteration for time zero to time aᵢₙₜ_{_{—}}₃·Δt, and is updated based on the temperature profile in the second iteration for time (aᵢₙₜ_{_{—}}₃+1)·Δt to time (N−1)·Δt. The time index “a” may be referred to as a cursor, in which the power scaling profile is updated to the right of the cursor on the time axis shown in FIG. 7. The temperature profile for the third iteration is then computed as follows:

\hat{T}_{1,int}_{_{—}}₃=Ĥ₁*(\hat{P}·Ĉᵢₙₜ_{_{—}}₃)+\hat{T}ₐ (22).

An error profile (error over time) may then be computed based on the temperature profiles for the second and third iterations. The error profile may then be evaluated to determine a point in time at which the error profile reaches the error threshold (denoted “ε”). This point in time corresponds to a new time t_{valid}, which may be at a later time than time t_{valid} computed in the second iteration. If the new time t_{valid} computed in the third iteration is the same as time t_{valid} computed in the second iteration, then the new time t_{valid} may be increased by one time step Δt. Thus, the new time t_{valid} computed in the third iteration is at least one time step later than time t_{valid} computed in the second iteration.

The iterative process then proceeds to a fourth iteration, in which a power scaling profile comprising a first portion and a second portion is computed. The first portion of the power scaling profile for the fourth iteration extends from time zero to time aᵢₙₜ_{_{—}}₄·Δt, and the second portion of the power scaling profile for the fourth iteration extends from time (aᵢₙₜ_{_{—}}₄+1)·Δt to time (N−1)·Δt, where time aᵢₙₜ_{_{—}}₄·Δt is set equal to time t_{valid} computed in the third iteration. The power scaling profile for the fourth iteration is computed as follows:

Ĉᵢₙₜ_{_{—}}₄=Cᵢₙₜ_{_{—}}₄[0], . . . , Cᵢₙₜ_{_{—}}₄[aᵢₙₜ_{_{—}}₄],Cᵢₙₜ_{_{—}}₄[aᵢₙₜ_{_{—}}₄+1], . . . , Cᵢₙₜ_{_{—}}₄[N−1]=Cᵢₙₜ_{_{—}}₃[0], . . . , Cᵢₙₜ_{_{—}}₃[aᵢₙₜ_{_{—}}₄],C′[T_{1,int}_{_{—}}₃[aᵢₙₜ_{_{—}}₄]], . . . , C′[T_{1,int}_{_{—}}₃[N−2]] (23)

Thus, the power scaling profile for the fourth iteration is kept the same from the power scaling profile in the third iteration for time zero to time aᵢₙₜ_{_{—}}₄·Δt, and is updated based on the temperature profile in the third iteration for time (aᵢₙₜ_{_{—}}₄+)·Δt to time (N−1)·Δt. Since time aᵢₙₜ_{_{—}}₄·Δt is at least one time step later than time aᵢₙₜ_{_{—}}₃·Δt, the portion of the power scaling profile that stays the same from the previous iteration (first portion) increases, and the portion of the power scaling profile that is updated (second portion) decreases. In other words, the position of the cursor “a” moves at least one time step to the right on the time axis in FIG. 7, and therefore the portion of the power scaling profile to the right of the cursor (the portion that is updated) decreases. The temperature profile for the fourth iteration is then computed as follows:

\hat{T}_{1,int}_{_{—}}₄=Ĥ₁*(\hat{P}·Ĉᵢₙₜ_{_{—}}₄)+\hat{T}ₐ (24).

An error profile may then be computed based on the temperature profiles for the third and fourth iterations. The error profile may then be evaluated to determine a point in time at which the error profile reaches the error threshold (denoted “ε”). The point in time corresponds to a new time t_{valid}, which may be later than time t_{valid} computed in the third iteration. If the new time t_{valid} is the same as time t_{valid} computed in the third iteration, then the new time t_{valid} may be increased by one time step Δt. The new time t_{valid} is used to define the first and second portions of the power scaling profile in a fifth iteration (set the position of the cursor “a” in the fifth iteration).

The iterative process may continue, in which time increases (moves to the right on the time axis in FIG. 7) by at least one time step in each subsequent iteration. As a result, the portion of the power scaling profile that stays the same (first portion) increases and the portion of the power scaling profile that is updated (second portion) decreases with each subsequent iteration. In other words, in each subsequent iteration, the cursor “a” moves to the right on the time axis, and therefore the portion of the power scaling profile to the right of the cursor “a” (the portion that is updated) decreases. The iterative process may stop when time t_{valid} reaches time (N−1)·Δt, at which point the entire temperature profile and power scaling profile may be considered valid. The controlled dynamic power profile for the circuit 115 may then be computed using the power scaling profile in the last iteration.

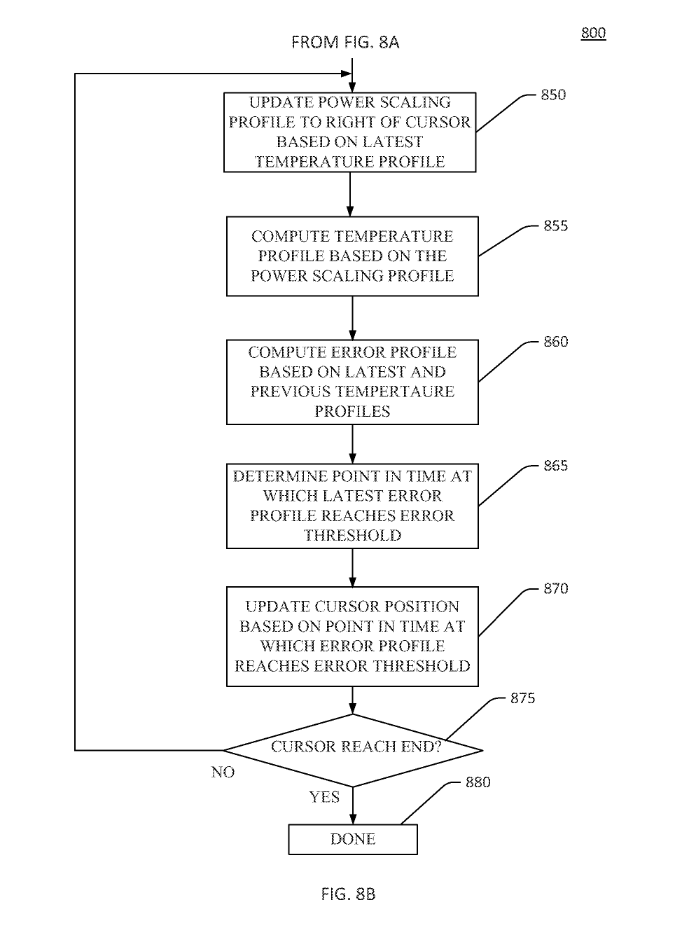

FIGS. 8A and 8B show a flowchart illustrating an iterative process 800 for determining a controlled power profile according to an embodiment of the present disclosure.

In step 810, a temperature profile is computed for a circuit (e.g., circuit 115). For example, the temperature profile may be computed by convolving a power profile for the circuit 115 with an impulse response at a location (e.g., location L1) within the circuit 115, and adding an ambient temperature (e.g., 25° C.).

In step 815, a determination is made whether the temperature profile crosses the temperature threshold. If the temperature profile does not cross the temperature profile, then the process 800 ends at step 820. This is because power scaling may not be activated in this case, and therefore may not need to be taken into account. Otherwise, the process 800 proceeds to step 825.

In step 825, a power scaling profile is determined based on the temperature profile. For example, the power scaling profile may be computed based on equation (19) above.

In step 830, a temperature profile is computed based on the power scaling profile. For example, the temperature profile may be computed based on equation (20) above.

In step 835, an error profile is computed based on the latest temperature profile and the previous temperature profile. The latest temperature profile corresponds to the temperature profile computed in step 830, and the previous temperature profile corresponds to the temperature profile computed in step 810.

In step 840, a cursor position corresponding to a point in time at which the error profile reaches an error threshold is determined. For example, the cursor position may correspond to time t_{valid} in the example shown in FIG. 7.

In step 850, the power scaling profile is updated to the right of the cursor based on the latest temperature profile. For the first time step 850 is performed, the latest temperature profile corresponds to the temperature profile computed in step 830. The portion of the power scaling profile from time zero to the cursor position may stay the same.

In step 855, a temperature profile is computed based on the power scaling profile. Step 855 is performed after the power scaling profile is updated in 850, and is therefore based on the latest update to the power scaling profile.

In step 860, an error profile is computed based on the latest temperature profile and the previous temperature profile. When step 860 is performed for the first time, the latest temperature profile corresponds to the temperature profile computed in step 855, and the previous temperature profile corresponds to the temperature profile computed in step 830.

In step 865, a point in time at which the latest error profile reaches the error threshold is determined. The latest error profile corresponds to the most recent error profile computed in step 860.

In step 870, the cursor position is updated based on the point in time at which the latest error profile reaches the error threshold.

In step 875, a determination is made whether the cursor has reached the end of the time sequence for the power scaling profile. If so, then the process 800 ends at step 880. Otherwise, the process 800 returns to step 850, in which case, steps 850 to 875 are repeated. Steps 850 to 875 may be repeated until the cursor reaches the end of the time sequence.

The iterative process for temperature-dependent power control was discussed above without leakage power for ease of discussion. However, it is to be appreciated that both leakage power and temperature-dependent control may be taken into account in a thermal simulation. For example, the iterative process for leakage power may be nested within the iterative process for temperature-dependent power control to account for leakage power. In this example, in the first iteration of the iterative process for temperature-dependent power control, the temperature profile may be computed using the iterative process for leakage power to account for leakage power. In each subsequent iteration of the iterative process for temperature-dependent power control, the controlled dynamic power profile may be updated as discussed above, and, after the controlled dynamic power profile is updated, the iterative process for leakage power may be performed to update the temperature profile to account for leakage power.

After the controlled dynamic power profile for the circuit 115 is determined, the temperature profile at each location L2 and L5 outside the circuit 115 may be updated by convolving the controlled dynamic power profile with the respective impulse response and adding the ambient temperature. For example, the temperature profile at location L2 may be computed in discrete-time form as follows:

\hat{T}₂=Ĥ₂*(\hat{P}·Ĉᵢₙₜ_{_{—}}ₗₐₛₜ)+\hat{T}ₐ (25)

where int_last denotes the last iteration in the iterative process. Thus, the temperature profiles at locations L2 and L5 may be updated to account for temperature-dependent power control at the circuit 115.

Therefore, embodiments of the present disclosure enable a designer to perform thermal simulations for a circuit with temperature-dependent power control. This allows the designer to adjust one or more parameters (e.g., PID coefficients) of a power controller (e.g., power controller 620), and determine how the adjustment affects the thermal and/or operational performance of the circuit. For example, the designer may perform thermal simulations for different values of the one or more parameters to determine which values provide good thermal and/or operational performance of the circuit (e.g., which values allow the circuit to operate continuously near the temperature threshold, thereby maximizing operational performance).

Embodiments of the present disclosure were described above using an example of a single heat source (i.e., the circuit 115) for ease of discussion. However, it is to be appreciated that embodiments of the present disclosure may be applied to a system comprising a plurality of heat sources (i.e., a plurality of circuit 115 consuming power), and are therefore not limited to a system comprising one heat source.

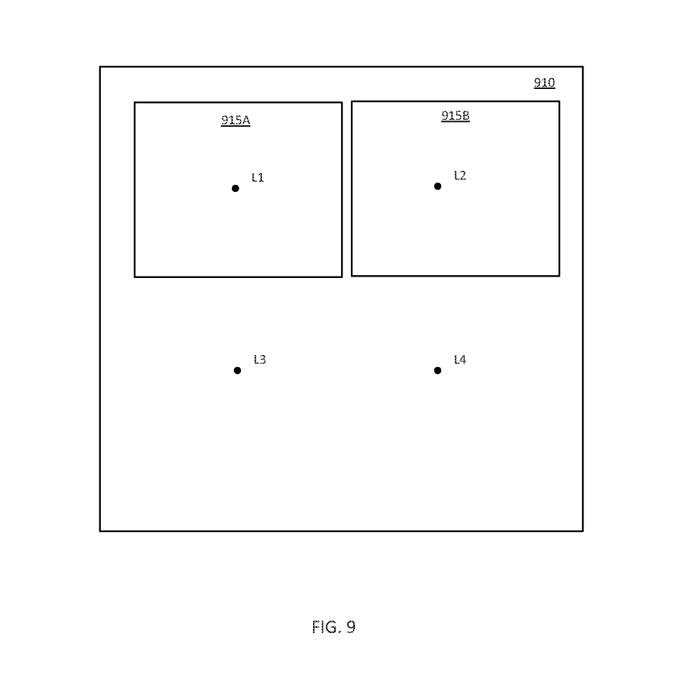

In this regard, FIG. 9 shows a simplified conceptual diagram of a chip (die) 910 comprising a first circuit 915A (e.g., first CPU) and a second circuit 915B (e.g., second CPU), where each circuit consumes power during operation, and therefore generates heat. Thus, the first circuit 915A may be considered a first heat source and the second circuit 915B may be considered a second heat source. FIG. 9 shows an example in which thermal responses to power consumption by the circuits 915A and 915B are determined at four locations on the chip 910 (denoted “L1” to “L4”). In this example, location L1 is within the first circuit 915A, location L2 is within the second circuit 915B, and locations L3 and L4 are outside of the circuit 115.

To characterize the thermal behavior of the chip 910, impulse responses may be determined at each location for each heat source (i.e., each circuit 915A and 915B). In this regard, a step power may be input to a state-space thermal simulator for the first circuit 915A with the second circuit 915B powered off. The thermal simulator may then compute a step response at each location L1 to L4 (i.e., thermal response at each location L1 to L4 to the step power at the first circuit 915A). After the step response at each location L1 to L4 is determined, an impulse response at each location L1 to L4 may be determined by computing a derivative of the respective step response with respect to time. The impulse response at each location L1 to L4 may be denoted by H_{m,n}(t), where the index m indicates the respective location and the index n indicates the respective heat source. For example, H_{1,1}(t) denotes the impulse response at location L1 corresponding to the first heat source (i.e., the first circuit 915A), H_{2,1}(t) denotes the impulse response at location L2 corresponding to the first heat source (i.e., the first circuit 915A), and so forth.

A step power may be input to a state-space thermal simulator for the second circuit 915B with the first circuit 915A powered off. The thermal simulator may then compute a step response at each location L1 to L4 (i.e., thermal response at each location L1 to L4 to the step power at the second circuit 915B). After the step response at each location L1 to L4 is determined, an impulse response at each location L1 to L4 may be determined by computing a derivative of the respective step response with respect to time. The impulse response at each location L1 to L4 may be denoted by H_{m,n}(t), where the index m indicates the respective location and the index n indicates the respective heat source. For example, H_{1,2}(t) denotes the impulse response at location L1 corresponding to the second heat source (i.e., the second circuit 915B), H_{2,2}(t) denotes the impulse response at location L2 corresponding to the second heat source (i.e., the second circuit 915B), and so forth.

After the impulse responses are determined, the thermal response at each location L1 and L4 to arbitrary power profiles at the first and second circuits 915A and 915B may be computed using convolution. For example, the thermal response at each location to arbitrary power profiles at the first and second circuits 915A and 915B may be computed as follows:

TRₘ(t)=H_{m,1}(t)*P₁(t)+H_{m,2}(t)*P₂(t) (26)

where * represents a convolution operation, P₁(t) is the power profile at the first circuit 915A, P₂(t) is the power profile at the second circuit 915B, TRₘ(t) is the thermal response, and the index m represents the respective location. The temperature profile at each location may be given by:

Tₘ(t)=H_{m,1}(t)*P₁(t)+H_{m,2}(t)*P₂(t)+Tₐ (27)

where Tₘ(t) is the temperature, Tₐ is the ambient temperature (e.g., 25° C.), and the index m represents the respective location. Thus, the temperature profile at each location may be determined by adding the ambient temperature to the respective thermal responses. Equation (27) can be expressed in discrete-time form as follows:

\hat{T}ₘ=Ĥ_{m,1}*\hat{P}₁+Ĥ_{m,2}*\hat{P}₂+\hat{T}ₐ (28)

Where Ĥ_{m,1} is the impulse response at location m corresponding to the first heat source (i.e., first circuit 915A), Ĥ_{m,2} is the impulse response at location m corresponding to the second heat source (i.e., second circuit 915B), \hat{P}₁ is the power profile corresponding to the first heat source (i.e., the first circuit 915A), and \hat{P}₂ is the power profile corresponding to the second heat source (i.e., the second circuit 915B).

An iterative process for determining leakage power at the first circuit 915A and the second circuit 915B will now be described according to certain embodiments. In a first iteration, the temperature profiles at locations L1 and L2 (locations within the first and second circuits 915A and 915B) are computed as follows:

\hat{T}_{1,int}_{_{—}}₁=Ĥ_{1,1}*\hat{P}₁+Ĥ_{1,2}*\hat{P}₂+\hat{T}ₐ

T_{2,int}_{_{—}}₁=Ĥ_{2,1}*\hat{P}₁+Ĥ_{2,2}*\hat{P}₂+\hat{T}ₐ (29)

where int denotes the iteration. In a second iteration, the temperature profiles at locations L1 and L2 are computed as follows:

\hat{T}_{1,int}_{_{—}}₂=Ĥ_{1,1}*(\hat{P}₁+\hat{L}₁(\hat{T}_{1,int}_{_{—}}₁₎))+Ĥ_{1,2}*(\hat{P}₂+\hat{L}₂(\hat{T}_{2,int}_{_{—}}₁))+\hat{T}ₐ

\hat{T}_{2,int}_{_{—}}₂=Ĥ_{2,1}*(\hat{P}₁+\hat{L}₁(\hat{T}_{1,int}_{_{—}}₁₎))+Ĥ_{2,2}*(\hat{P}₂+\hat{L}₂(\hat{T}_{2,int}_{_{—}}₁))+\hat{T}ₐ (30)

where \hat{L}₁( ) is the leakage power at location L1 as a function of temperature at location L1, and \hat{L}₂( ) is the leakage power at location L2 as a function of temperature at location L2.

After the second iteration, an error value (e.g., MSE) may be computed based on the difference between the temperature profiles for the first iteration and the temperature profiles for the second iteration. If the error value is below an error threshold (which may be close to zero), then the iterative process may stop. Otherwise, the iterative process may proceed to a third iteration.

In the third iteration, the temperature profiles at locations L1 and L2 are computed as follows:

\hat{T}_{1,int}_{_{—}}₃=Ĥ_{1,1}*(\hat{P}₁+\hat{L}₁(\hat{T}_{1,int}_{_{—}}₂₎))+Ĥ_{1,2}*(\hat{P}₂+\hat{L}₂(\hat{T}_{2,int}_{_{—}}₂))+\hat{T}ₐ

\hat{T}_{2,int}_{_{—}}₃=Ĥ_{2,1}*(\hat{P}₁+\hat{L}₁(\hat{T}_{1,int}_{_{—}}₂₎))+Ĥ_{2,2}*(\hat{P}₂+\hat{L}₂(\hat{T}_{2,int}_{_{—}}₂))+\hat{T}ₐ (31)

Thus, the leakage power profile at each location in the third iteration is computed based on the temperature profile at the respective location in the second iteration. After the third iteration, an error value (e.g., MSE) may be computed based on the difference between the temperature profiles for the second iteration and the temperature profiles for the third iteration. If the error value is below the error threshold, then the iterative process stops. Otherwise, the iterative process may proceed to a fourth iteration.

In each subsequent iteration of the iterative process, the leakage power profiles at locations L1 and L2 for the iteration are computed based on the temperature profiles at locations L1 and L2 from the previous iteration. The iterative process may continue until the error value between the temperature profiles for two consecutive iterations is below the error threshold. When the iterative process ends, the leakage powers computed in the last iteration may be used to compute the combined power profile at each of the circuits 915A and 915B.

After the combined power profiles for the first and second circuits 915A and 915B are determined using the iterative process, the temperature profile at each location L3 and L4 outside the first and second circuits 915A and 915B may be computed as follows:

\hat{T}₃=Ĥ_{3,1}*(\hat{P}₁+\hat{L}₁(T_{1,int}_{_{—}}ₗₐₛₜ₎))+Ĥ_{3,2}*(\hat{P}₂+\hat{L}₂(\hat{T}_{2,int}_{_{—}}ₗₐₛₜ))+Tₐ

\hat{T}₄=Ĥ_{4,1}*(\hat{P}₁+\hat{L}₁(T_{1,int}_{_{—}}ₗₐₛₜ₎))+Ĥ_{4,2}*(\hat{P}₂+\hat{L}₂(\hat{T}_{2,int}_{_{—}}ₗₐₛₜ))+Tₐ (32)

where int_last denotes the last iteration in the iterative process. Thus, the temperature profiles at locations L3 and L4 may be updated to account for leakage power at the first and second circuits 915A and 915B.

Thus, the iterative process for leakage power may be applied to two or more heat sources, in which the leakage powers at the two or more heat sources are updated in parallel in each iteration. In other words, in each iteration of the iterative process, the leakage powers at the two or more heat sources are updated based on the temperature profiles at the two or more heat sources (locations L1 and L2 in the above example) from the previous iteration. It is to be appreciated that the iterative process for temperature-dependent power control may be similarly applied to two or more circuits, in which the dynamic power at each circuit is controlled based on temperature at the respective circuit. For example, the power scaling profiles for the two or more circuits may be updated in parallel in each iteration.

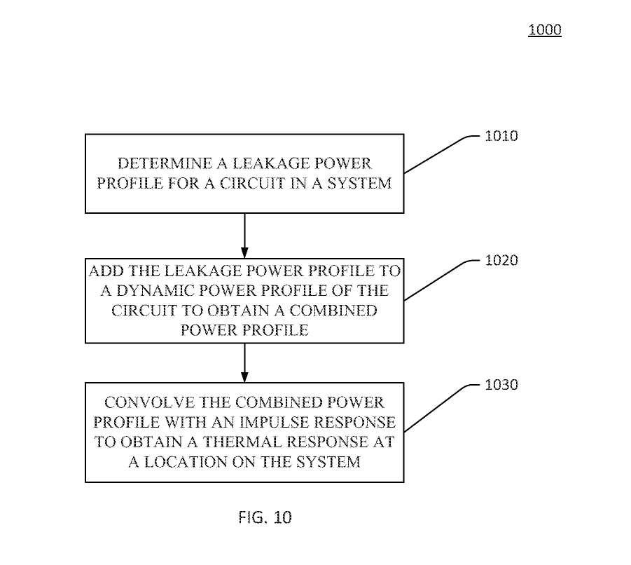

FIG. 10 is a flowchart illustrating a method 1000 for thermal simulation according to an embodiment of the present disclosure. In step 1010, a leakage power profile for a circuit in a system is determined. For example, the leakage power profile may be determined based on a temperature profile at the circuit (e.g., circuit 115).

In step 1020, the leakage power profile is added to a dynamic power profile of the circuit to obtain a combined power profile. The dynamic power profile may be power consumption due to, for example, transistor switching in the circuit (e.g., circuit 115).

In step 1030, the combined power profile is convolved with an impulse response to obtain a thermal response at a location on the system. For example, the impulse response may be obtained by computing a thermal step response at the location to a step power at the circuit, and computing a derivative of the step response with respect to time.

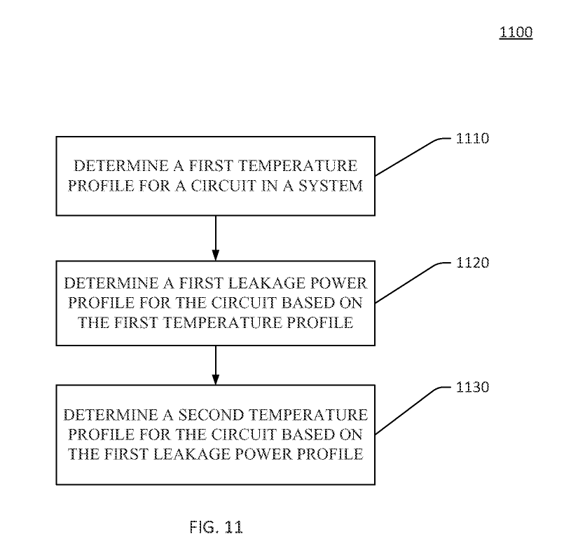

FIG. 11 is a flowchart illustrating a method 1100 for thermal simulation according to another embodiment of the present disclosure. In step 1110, a first temperature profile for a circuit in a system is determined. For example, the first temperature profile may be determined by convolving a dynamic power profile of the circuit with an impulse response. In this example, the first temperature profile may be determined based on an assumption that leakage power is approximately zero.

In step 1120, a first leakage power profile for the circuit is determined based on the first temperature profile.

In step 1130, the second temperature profile for the circuit is determined based on the first leakage power profile. For example, the second temperature profile may be computed by adding the first leakage power profile to the dynamic power profile to obtain a combined power profile, and convolving the combined power profile with the impulse response.

The method 1100 may optionally include determining an error value based on the first and second temperature profiles, and comparing the error value to an error threshold. The method 1100 may also optionally include, if the error value is above the error threshold, performing the steps of determining a second leakage power profile based on the second temperature profile, and determining a third temperature profile based on the second leakage power profile.

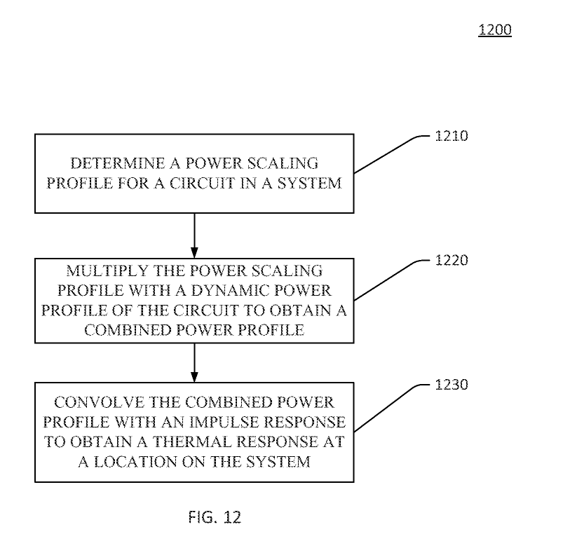

FIG. 12 is a flowchart illustrating a method 1200 for thermal simulation according to yet another embodiment of the present disclosure. In step 1210, a power scaling profile for a circuit in a system is determined. For example, the power scaling profile may be a function of temperature at the circuit for temperature-dependent power control.

In step 1220, the power scaling profile is multiplied with a dynamic power profile of the circuit to obtain a combined power profile. The power scaling profile may have a range between zero and one.

In step 1230, the combined power profile is convolved with an impulse response to obtain a thermal response at a location on the system. For example, the impulse response may be obtained by computing a thermal step response at the location to a step power at the circuit, and computing a derivative of the step response with respect to time.

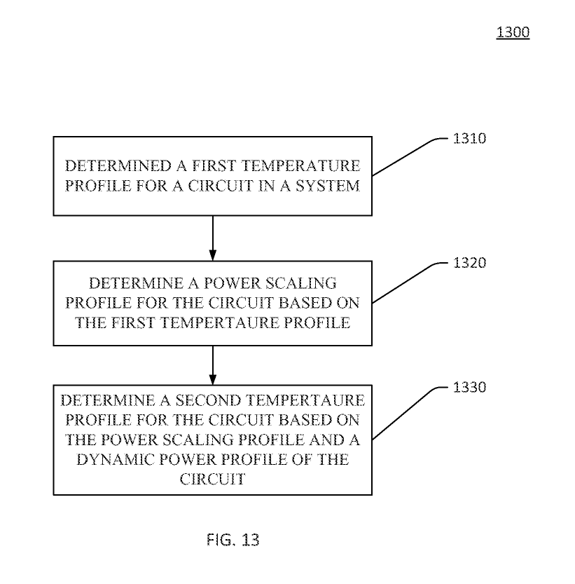

FIG. 13 is a flowchart illustrating a method 1300 for thermal simulation according to still another embodiment of the present disclosure. In step 1310, a first temperature profile for a circuit in a system is determined. For example, the first temperature profile may be computed by convolving a dynamic power profile with an impulse response.

In step 1320, a power scaling profile for the circuit is determined based on the first temperature profile.

In step 1330, a second temperature profile for the circuit is determined based on the power scaling profile and a dynamic power profile of the circuit. For example, the second temperature profile may be computed by multiplying the power scaling profile with the dynamic power profile to obtain a combined power profile (e.g., controlled dynamic power profile), and convolving the combined power profile with an impulse response.

The method 1300 may optionally include determining an error profile based on the first and second temperature profiles, and determining a point in time at which the error profile reaches an error threshold. The method 1300 may further optionally include updating a portion of the power scaling profile corresponding to a time range after the determined point in time. For example, the updated portion may be to the right of the point in time (e.g., time t_{valid}) on a time axis.

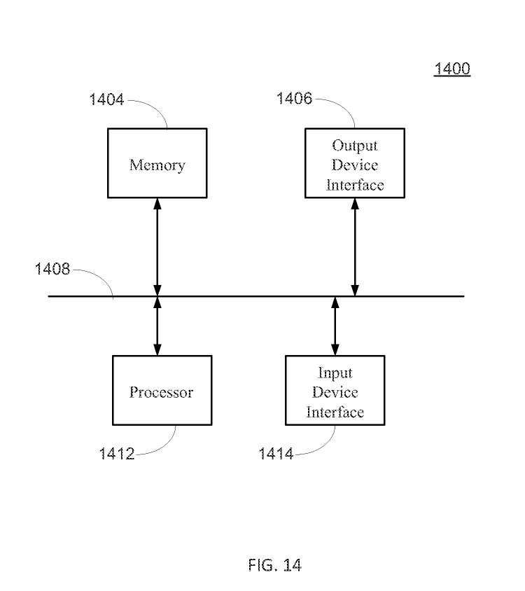

FIG. 14 illustrates an electronic system 1400 with which features of the subject technology may be implemented. The electronic system 1400 includes a bus 1408, a processor 1412, a memory 1404, an input device interface 1414, and an output device interface 1406. The bus 1408 collectively represents all system buses that communicatively couple the numerous devices of the electronic system 1400. For instance, the bus 1408 communicatively couples the processor 1412 with the memory 1404.

In operation, the processor 1412 may retrieve instructions from the memory 1404 for performing one or more of the functions described herein, and execute the instructions to perform the one or more functions. For example, processor 1412 may retrieve instructions for performing one or more thermal simulations of a system according to any of the embodiments discussed above, and execute the instructions to perform the one or more thermal simulations. The processor 1412 may perform the one or more thermal simulations based on a thermal model of the system stored in the memory 1404, and may store results of the one or more thermal simulations in the memory 1404. The processor 1412 may be a single processor or a multi-core processor in different implementations. The memory 1404 may comprise a radon access memory (RAM), a read only memory (ROM), a flash memory, registers, a hard disk, a removable disk, a CD-ROM, any other form of storage medium known in the art, or any combination thereof.

The bus 1408 may also couple to the input and output device interfaces 1414 and 1406. The input device interface 1414 may enable a user to communicate information and select commands to the electronic system 1400, and may include, for example, an alphanumeric keyboard and a pointing device (e.g., a mouse). For example, the user may use the input device interface to command the processor 1412 to perform a particularly thermal simulation. The output device interface 1406 may enable, for example, the display of information generated by the electronic system 1400 to a user, and may include, for example, a display device (e.g., liquid crystal displays (LCD)). For example, the output device interface 1406 may be used to display results of a thermal simulation to the user.

The steps of a method or algorithm described in connection with the disclosure herein may be embodied directly in hardware, in a software module executed by a processor (e.g., processor 1412), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium (e.g., memory 1404) may be coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored as one or more instructions or code on a computer-readable medium. Computer-readable media may include a computer storage media. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a general-purpose or special-purpose computer.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A computer-implemented method for thermal simulation, comprising:
determining a leakage power profile for a circuit in a system;
adding the leakage power profile to a dynamic power profile of the circuit to obtain a combined power profile; and
convolving the combined power profile with an impulse response to obtain a thermal response at a location on the system.

2. The method of claim 1, wherein determining the leakage power profile comprises:
convolving the dynamic power profile of the circuit with the impulse response to obtain a temperature profile; and
determining the leakage power profile based on the temperature profile.

3. The method of claim 1, further comprising:
determining a thermal step response at the location to a step power at the circuit; and
computing a derivative of the thermal step response with respect to time to obtain the impulse response.

4. The method of claim 3, wherein the location is within the circuit.

5. The method of claim 1, further comprising adding an ambient temperature to the thermal response.

6. A computer-implemented method for thermal simulation, comprising:
determining a first temperature profile for a circuit in a system;
determining a first leakage power profile for the circuit based on the first temperature profile; and
determining a second temperature profile for the circuit based on the first leakage power profile.

7. The method of claim 6, wherein determining the first temperature profile comprises convolving a dynamic power profile of the circuit with an impulse response at a location on the system.

8. The method of claim 7, wherein the location is within the circuit.

9. The method of claim 7, wherein the first temperature profile is determined based on an assumption that leakage power at the circuit is approximately zero.

10. The method of claim 6, wherein determining the second temperature profile comprises:
adding the first leakage power profile to a dynamic power profile of the circuit to obtain a combined power profile; and
convolving the combined power profile with an impulse response.

11. The method of claim 10, further comprising:
determining a thermal step response to a step power at the circuit; and
computing a derivative of the thermal step response with respect to time to obtain the impulse response.

12. The method of claim 6, further comprising:
determining an error value based on the first and second temperature profiles;
comparing the error value to an error threshold; and
if the error value is above the error threshold, performing the steps of:
determining a second leakage power profile based on the second temperature profile; and
determining a third temperature profile based on the second leakage power profile.

13. A computer-implemented method for thermal simulation, comprising:
determining a power scaling profile for a circuit in a system;
multiplying the power scaling profile with a dynamic power profile of the circuit to obtain a combined power profile; and
convolving the combined power profile with an impulse response to obtain a thermal response at a location on the system.

14. The method of claim 13, wherein determining the power scaling profile comprises:
convolving the dynamic power profile of the circuit with the impulse response to obtain a temperature profile; and
determining the power scaling profile based on the temperature profile.

15. The method of claim 13, further comprising:
determining a thermal step response at the location to a step power at the circuit; and
computing a derivative of the thermal step response with respect to time to obtain the impulse response.

16. The method of claim 15, wherein the location is within the circuit.

17. The method of claim 13, further comprising adding an ambient temperature to the thermal response.

18. A computer-implemented method for thermal simulation, comprising:
determining a first temperature profile for a circuit in a system;
determining a power scaling profile for the circuit based on the first temperature profile; and
determining a second temperature profile for the circuit based on the power scaling profile and a dynamic power profile of the circuit.

19. The method of claim 18, wherein determining the second temperature profile comprises:
multiplying the power scaling profile with the dynamic power profile to obtain a combined power profile; and
convolving the combined power profile with an impulse response.

20. The method of claim 19, wherein the location is within the circuit.

21. The method of claim 19, further comprising:
determining a thermal step response to a step power at the circuit; and
computing a derivative of the thermal step response with respect to time to obtain the impulse response.

22. The method of claim 18, further comprising:
determining an error profile based on the first and second temperature profiles;
determining a point in time at which the error profile reaches an error threshold; and
updating a first portion of the power scaling profile corresponding to a time range after the determined point in time.

23. The method of claim 22, wherein a second portion of the power scaling profile corresponding to a time range before the determined point in time is not updated.

24. The method of claim 22, wherein the first portion of the power scaling profile is updated based on the second temperature profile.

25. The method of claim 22, further comprising determining a third temperature profile based on the updated power scaling profile and the dynamic power profile.
